(19) United States
(12) Patent Application Publication
(10) Pub. No.: US 2008/0258631 A1
(43) Pub. Date: Oct. 23, 2008

(54) Light-adjusting and current-limiting control circuit

(75) Inventors: Ai-Min Wu, Shenzhen (CN); Hai-Ting Huang, Shenzhen (CN)

Correspondence Address: BACON & THOMAS, PLLC, 625 SLATERS LANE, FOURTH FLOOR, ALEXANDRIA, VA, 22314-1176, US

(73) Assignee: FUMONG TECHNOLOGY ( SHENZHEN ) LTD., Shenzhen (CN)

(21) Appl. No.: 12/010,916

(22) Filed: Jan. 31, 2008

(30) Foreign Application Priority Data
Apr. 18, 2007 (CN) 200720050630.5

(51) Int. Cl. H05B 37/00; H05B 41/36

(52) U.S. Cl. 315/129; 315/291

(57) ABSTRACT

A light-adjusting and current-limiting control circuit for a lamp includes a sampling circuit formed of a manganese-copper line or a current transformer, a power circuit provided with resistors, capacitors, diodes, a Varistor and a zener diode, a signal adjusting circuit composed of diodes, resistors, a varistor, triacs and capacitors, and a control output circuit having a thyristor, diodes, a relay and an LED. The control output circuit can be replaced with a light-adjusting input circuit, a chip processor control circuit, a zero-crossing detection circuit and a two-way silicon controlled rectifier control output circuit 5. Thus, the invention has a low cost, a small size and an excellent precision, compared to conventional ones.

### BACKGROUND OF THE INVENTION

1. Field of the Invention

This invention relates to an automatic control circuit for a lamp, particularly to one able to adjust light and to restrict power load.

2. Description of the Prior Art

A current-limiting control circuit is one restricted with a certain load power. The commercial current-limiting circuits are mostly based on general IC of the model LM324 or LM358, with its block chart divided into a sampling circuit, a rectifying-filtrating circuit, an amplifying-comparing circuit and an output control circuit. The amplifying-comparing circuit usually gets sampling signals by a manganese-copper line, which are then amplified by an operational amplifier, or uses a transducer to sample signals that are then output by a comparator to control an on/off between a silicon controlled rectifier and a relay, so as to turn off a load to achieve the purpose of restricting power. However, as the magnetic core of the transducer possesses discreteness to make parameters difficulty controlled to be consistent while manufacturing, its productivity is hard to be advanced to result in a high cost. In addition, it is as well to have a high cost by employing the operational amplifier. Therefore, the current commercial current-limiting circuits have not only a high cost of manufacturing and maintenance, but also a low stability and precision.

Furthermore, according to the requirements of Energy Star in USA, the total power consumption for a lamp with plural lights must be less than 190 watts and that for a lamp with a single light can not surpass 50 watts; as for movable lamps, they should be additionally available for a light-adjusting function. But, the commercial lamps are installed with only the light-adjusting function or the current-limiting function. If the lamps are to be exported to USA, the two functions have to be added together, possible to greatly increase cost.

### SUMMARY OF THE INVENTION

The objective of this invention is to offer a light-adjusting and current-limiting control circuit with a low cost, a small size and a good precision.

The main characteristics of the invention are a sampling circuit formed of a manganese-copper line or a current transformer, a power circuit provided with resistors, capacitors, diodes, a varistor and a zener diode, a signal adjusting circuit composed of diodes, resistors, a varistor, triacs and capacitors, and a control output circuit having a thyristor, diodes, a relay and an LED. The control output circuit can be replaced with a light-adjusting input circuit, a chip processor control circuit, a zero-crossing detection circuit and a two-way silicon controlled rectifier control output circuit.

### BRIEF DESCRIPTION OF DRAWINGS

This invention is better understood by referring to the accompanying drawings, wherein:

FIG. 1 is a circuit diagram of a first preferred embodiment of a light-adjusting and current-limiting control circuit in the present invention;

FIG. 2 is a circuit diagram of a second preferred embodiment of a light-adjusting and current-limiting control circuit in the present invention;

FIG. 3 is a circuit diagram of a third preferred embodiment of a light-adjusting and current-limiting control circuit in the present invention; and

FIG. 4 is a circuit diagram of a fourth preferred embodiment of a light-adjusting and current-limiting control circuit in the present invention.

### DETAILED DESCRIPTION OF THE PREFERRED EMBODIMENT

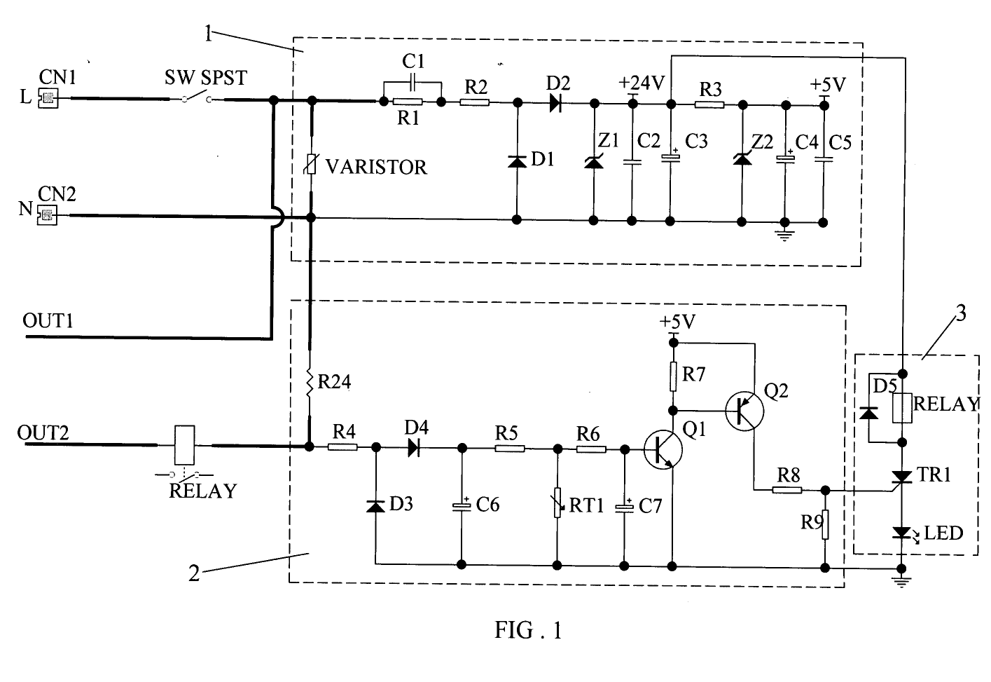

As shown in FIG. 1, a first preferred embodiment of a light-adjusting and current-limiting control circuit in the present invention includes a sampling circuit, a power circuit 1, a signal adjusting circuit 2 and a control output circuit 3. The sampling circuit is composed of a resistor R24. The power circuit 1 includes three resistors R1, R2 and R3, four capacitors C1, C3, C4 and C5, two diodes D1 and D2, a varistor and a zener diode Z2. The signal adjusting circuit 2 includes a diode D4, six resistors R4, R5, R6, R7, R8 and R9, a varistor RT1, two triacs Q1 and Q2, and two capacitors C6 and C7. The control output circuit 3 includes a thyristor TRI, a diode D5, a relay and an LED. How they are connected is described below.

Subsequently connected in series from an input port CN3 are a switch SW SPST, the resistors R1 and R2, the diode D2 and the resistor R3; the resistor R3 is connected to the negative pole of the diode D2; the capacitor C1 is connected with the resistor R1 in parallel; the diode D1 is connected between the positive pole of the diode D2 and the ground in parallel, wherein the positive pole of the diode D1 is connected to the ground; the capacitor C3 is connected between the negative pole of the diode D2 and the ground in parallel, wherein the negative pole of the capacitor C3 is connected to the ground; the zener diode Z2 and the capacitors C4 and C5 are connected between the resistor R3 and the ground in parallel, wherein the positive pole of the zener diode Z2 is connected to the negative pole of the capacitor C4.

The input port CN4 is connected to the ground, and the output port OUT1 is connected between the switch SW SPST and the resistor R1. The output port OUT2 is connected to the ground by passing through a control port of the relay and the resistor R24.

Next, orderly connected between the resistor R1, the control port of the relay and the base of the triac Q1 in series are the resistor R4, the diode D4 and the resistors R5 and R6. The emitter of the triac Q1 is connected to the ground. The capacitor C7 is connected between the base of the triac Q1 and the ground in parallel, with the negative pole of the capacitor C7 connected to the ground. Connected between the resistor R5 and R6 is the varistor RT1 that is also connected to the ground in parallel. The negative pole of the diode D4 is connected with the capacitor C6 that has its negative pole connected to the ground in parallel. The collector of the triac Q1 passes through the resistor R7 to connect to the negative pole of the zener diode Z2. The base of the triac Q2 is connected to the collector of the triac Q1. The emitter of the triac Q2 is connected to the negative pole of the zener diode Z2. The collector of the triac Q2 passes through the resistor R8 to connect to the gate of the thyristor TR1. The resistor R9 is connected between the gate of the thyristor TR1 and the ground. The LED is connected between the cathode of the Thyristor TR1 and the ground, employed to indicate if the thyristor TR1 is connected or not. The anode of the thyristor TR1 passes through the relay to connect to the positive pole of the capacitor C3. The diode D5 is connected between two ends of the relay in parallel, with the positive pole of the diode D5 connected to the anode of the thyristor TR1.

The input ports CN3 and CN4 are connected with an input, such as 120V/60 Hz and 220V/50 Hz etc; generally, the input port CN4 is connected with the zero line (denoted as N) of the power line (not shown) and the input port CN3 is connected with the fire line (denoted as L) of the power line (not shown); the output ports OUT1 and OUT2 are respectively connected to a load such as a lamp (not shown).

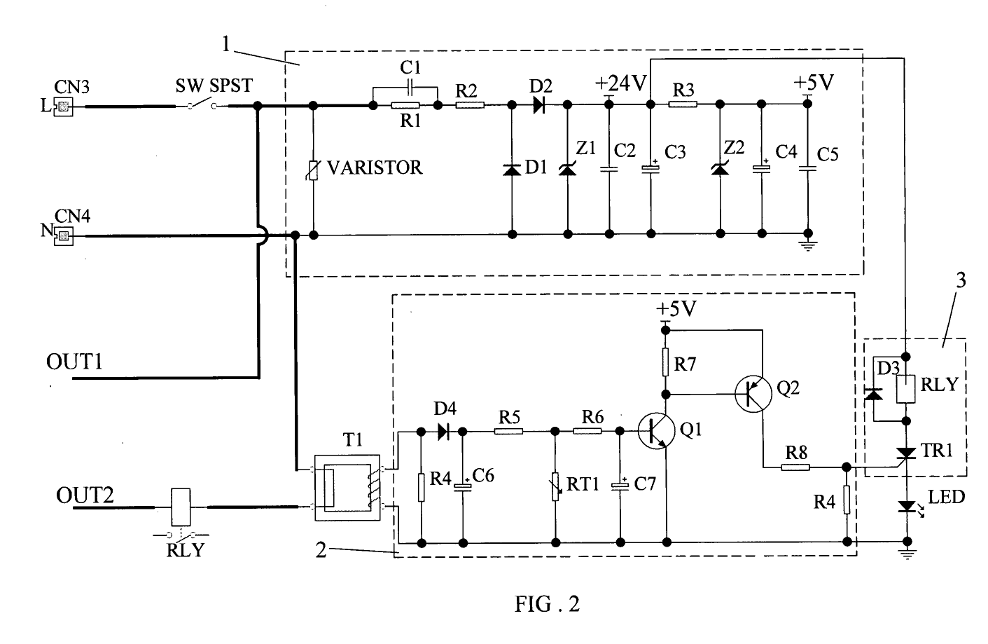

A first feature of the preferred embodiment, as shown in FIGS. 1 and 2, is that a zener diode Z1 is connected between the negative pole of the diode D2 and the ground, having its anode connected to the ground. By means of the zener diode Z1, the voltage at two ends of the capacitor C3 can be stabilized to have a high reliability.

A second feature of the preferred embodiment, as shown in FIGS. 1 and 2, is that a capacitor C2 is connected between two ends of the zener diode Z1 in parallel.

A third feature of the preferred embodiment is that the zener diode Z1 is of 24 volts, with 24 volts at its negative pole to be provided for the control output circuit 3, and the zener diode Z2 is of 5.6 volts, with 5 volts at its negative pole to be provided for signal adjusting circuit 2. A chip processor control circuit 7 needs 5 volts.

As shown in FIG. 2, a second preferred embodiment of a light-adjusting and current-limiting control circuit in the present invention has the same components as the first embodiment does, except that the sampling circuit is a current transformer T1, which has its input connected at two ends of the resistor R4, one of its outputs passed through the control port of the relay to connect to the output port OUT2, and the other output connected to the input port CN4. Similar to a hearting inductor, the current of a load can induce the output of the current transformer T1 as a voltage signal that is to pass through the signal adjusting circuit 2 to control the Relay or to send to a chip processor U1 for detecting. The sampling circuit based on the current transformer T1 is better than that based on manganese-copper line.

As shown in FIG. 1, a fourth feature of the preferred embodiment, is that the diode D3 has its negative pole connected to between the positive pole of the diode D4 and the resistor R4, and its positive pole connected to the ground, keeping the present invention to run more stably.

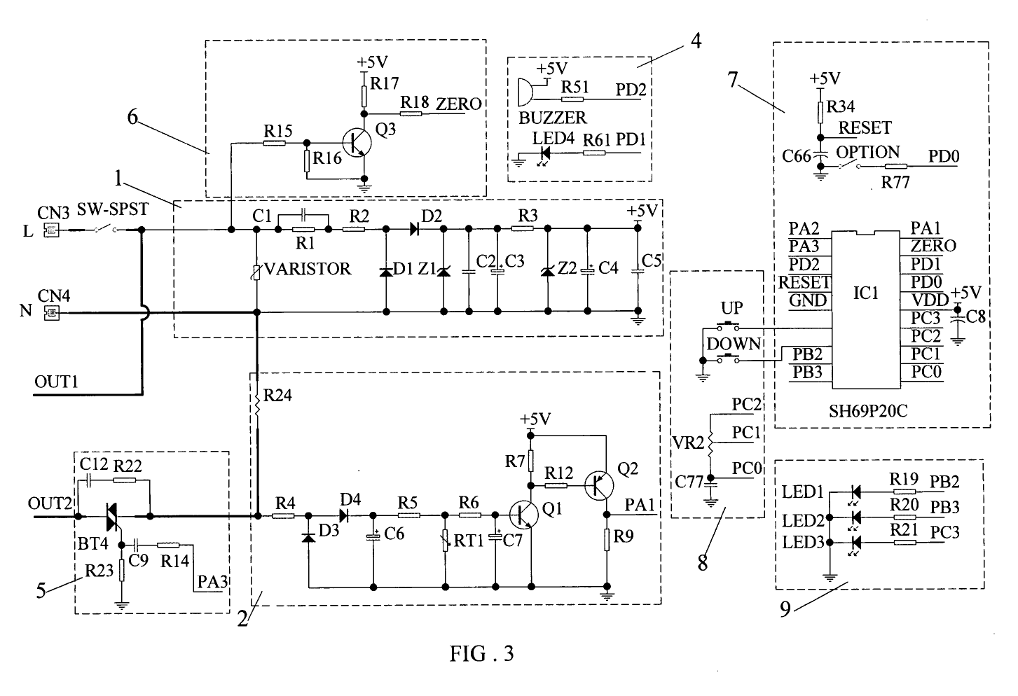

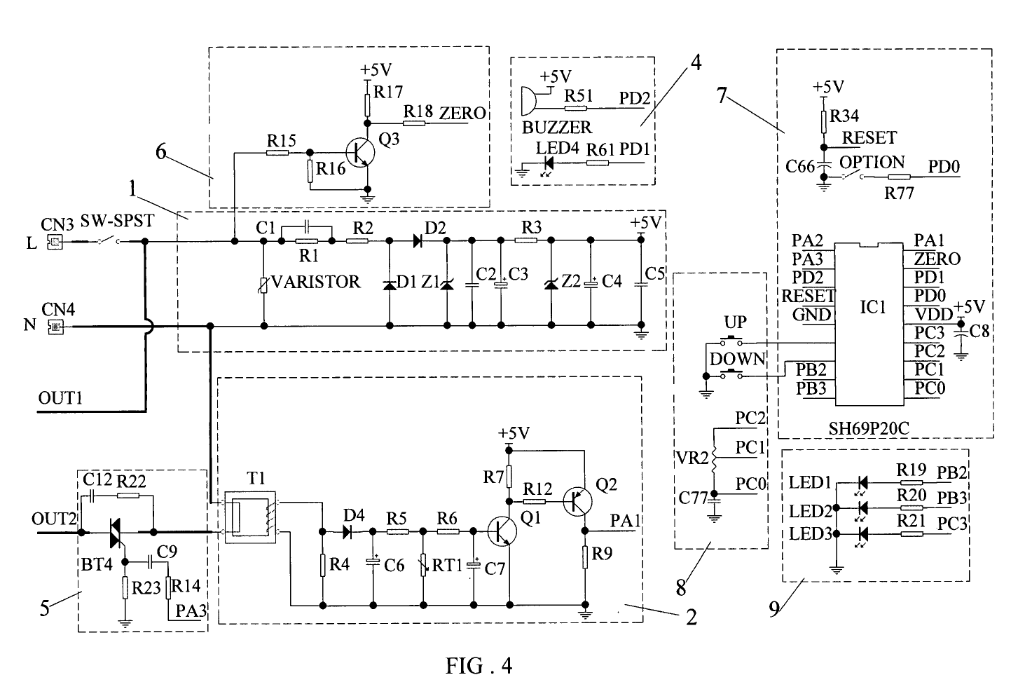

As shown in FIGS. 3 and 4, a third and a fourth preferred embodiment of a light-adjusting and current-limiting control circuit in the present invention has the same components as the first embodiment does, except additionally having at least a silicon controlled rectifier control output circuit 5, a zero-crossing detection circuit 6, a chip processor control circuit 7 and a light-adjusting input circuit 8. The silicon controlled rectifier control output circuit 5 includes a two-way silicon controlled rectifier BT4, three resistors R22, R23 and R14, and two capacitors C9 and C12. The zero-crossing detection circuit 6 includes four resistors R15, R16, R17 and R18, and a triac Q3. The chip processor control circuit 7 includes a chip processor U1, two resistors R34 and R77, two capacitors C66 and C8, and a switch (option). The light-adjusting input circuit 8 uses a light-adjusting button and/or a light-adjusting Varistor to carry out adjusting light brightness, depending on different environments. The light-adjusting button can be single or double. The double one includes an UP button and a DOWN button. The light-adjusting Varistor includes a Varistor VR2 and a capacitor C77. The control output circuit 3 includes a triac Q4, a diode D5, a relay and a resistor R44. The model of the chip processor U1 is SH69P20C. The control output circuit 3 is replaced with the silicon controlled rectifier control output circuit 5. How they are connected is a fifth feature of the preferred embodiment, described below.

The fifth feature is that two-way silicon controlled rectifier BT4 has its one electrode connected to the output port OUT2, its another electrode connected to the resistor R24 or one output port of the current transformer T1, and its gate connected to the ground after passing through the resistor R23. The capacitor C9 and the resistor R14 are subsequently connected between the gate of the two-way silicon controlled rectifier BT4 and a pin PA3 of the chip processor U1 in series. The capacitor C12 and the resistor R22 are connected at two electrodes of the two-way silicon controlled rectifier BT4 in parallel after connected each other in series. When the chip processor U1 detects a zero-crossing signal, the conducting time of the two-way silicon controlled rectifier BT4 in each period of sine wave is controlled in accordance to the present light-adjusting input. It is characterized that the two-way silicon controlled rectifier BT4 is to stop output when the sine signal is zero-crossing. Therefore, the chip processor U1 needs to continuously detect zero-crossing signals so as to prompt the two-way silicon controlled rectifier BT4 conducted after every zero-crossing point. So, by adjusting the lag time initiated after zero-crossing point, adjusting light can be effected. In addition, combined with the sampling circuit and the signal adjusting circuit 2, the silicon controlled rectifier control output circuit 5 can also achieve the purpose of restricting power.

A sixth feature of the preferred embodiment is that the base of the triac Q3 passes through the resistor R15 to connect to the output port OUT1. The resistor R16 is connected between the base of the triac Q3 and the ground in parallel. The triac Q3 has its emitter connected to the ground, and its collector passes through the resistor R17 to connect to the negative pole of the zener diode Z2 and passes through the resistor R18 to connect to the zero pin of the chip processor U1 (the 17th pin of the chip processor U1). A bias formed of the triac Q3 step-downed via the resistors R15 and R16 is employed to control the conducting of the triac Q3. With a sine signal inputted to pass through a voltage dividing circuit formed of the resistors R15 and R16, its signal is weak near zero point so as to be insufficient to enable the triac Q3 conducted after passing through the resistors R15 and R16. By the time, the zero pin of the chip processor U1 is high frequency. As the range of the sine signal is slightly widened, the triac Q3 is to be initiated to get conducted, thus altering the zero pin of the chip processor U1 into low frequency. Therefore, via the zero-crossing detection circuit 6, the sine signal can be converted into a square wave signal so as to enable the chip processor U1 to detect zero point of the sine signal.

A seventh feature of the preferred embodiment is that the chip processor U1 has its VDD pin (the 14th one) connected to the negative pole of the zener diode Z2 and passed through the capacitor C8 to connect to the ground, its PD0 pin (the 15th one) passed through the resistor R77 and the switch (option) to connect to the ground, and its RESET pin (the 4th one) passed through the capacitor C66 to connect to the ground and passed through the resistor R34 to connect to the negative pole of the zener diode Z2.

An eighth feature of the preferred embodiment is that the varistor VR2 has its two ends respectively connected to the PC2 pin (the 12th one) and the PC0 pin (the 10th one) of the chip processor U1, and its intermediate pin connected to the PC1 pin (the 11th one) of the chip processor U1. The PC0 pin of the chip processor U1 passes through the capacitor C77 to connect to the ground.

A ninth feature of the preferred embodiment is that the button UP is connected between the PB0 pin (the 6th one) of the chip processor U1 and the ground, and the button DOWN is connected between the PB1 pin (the 7th one) of the chip processor U1 and the ground.

A tenth feature of the preferred embodiment is that the triac Q2 has its collector connected to the PA1 pin (the 18th one), and its base connected to the collector of the triac Q1 through a resistor R12.

So, combined with the silicon controlled rectifier control output circuit 5, the zero-crossing detection circuit 6, the chip processor control circuit 7 and the light-adjusting input circuit 8, the chip processor U1 with its programmable characteristics can control the relay and the two-way silicon controlled rectifier BT4 to adjust light and restrict power. When the single button of light-adjusting is selected, a user can press a button 2s to control light brightness by means of the chip processor U1 to pass through the two-way silicon controlled rectifier BT4, from the brightest to the darkest and vice versa, and can release the button while obtaining a desired brightness. The chip processor U1 can keep controlling the tungsten lamp to steadily maintain the ongoing brightness output, obtaining a humanistic and energy-efficient lamp. If the double button of light-adjusting is selected, the button UP is used to control the brightness of a load, such as a tungsten lamp (not shown), from the brightest to the darkest, and the button DOWN is employed to control the brightness of a load, such as a tungsten lamp (not shown), from the darkest to the brightest. When the desired brightness is presently adjusted, it can be maintained stably by releasing the button. The alternation of the brightness is stepless. Similarly, a user can also move the sliding switch (not shown) of the varistor to enable the chip processor U1 to control the brightness change of a load such as a tungsten lamp (not shown), with an adjusting scope ranging from 0˜100%.

An eleventh feature of the preferred embodiment, in addition, as shown in FIGS. 3 and 4, is that a sound and light warning circuit 4 is additionally included, provided with a buzzer warning circuit and/or a LED warning circuit. The buzzer warning circuit consists of a buzzer and a resistor R51, with one pin of the buzzer passing through the resistor R51 to connect to the PD2 pin of the chip processor U1, and the other pin of the buzzer connected to the negative pole of the zener diode Z2. The LED warning circuit consists of a LED4 and a resistor R61, with the negative pole of the LED4 connected to the ground, and the positive pole of the LED4 passing through the resistor R61 to connect to the PD1 pin of the chip processor U1. When a load such as a lamp (not shown) is turn on, the chip processor U1 can detect current passing through the load, able to control the silicon controlled rectifier and/or the relay to stop the load working if detecting current running through the load surpasses the restricted value, enabling the buzzer to sound and/or the LED to flash for reminding a user to replace the load with a proper one. Either or both of the buzzer and the LED can be chosen as warning devices.

Furthermore, as shown in FIGS. 3 and 4, a twelfth feature is that an LED indicating circuit 9 is as well included in the third and the fourth embodiment of the present invention, composed of three light emitting diodes LED1, LED2 and LED3, and three resistors R19, R20 and R21. The LED1 has its negative pole connected to the ground, and its positive pole passed through the resistor R19 to connect to the PB2 pin (the 8th one) of the chip processor U1. The LED2 has its negative pole connected to the ground, and its positive pole passed through the resistor R20 to connect to the PB3 pin (the 9th one) of the chip processor U1. The LED3 has its negative pole connected to the ground, and its positive pole passed through the resistor R21 to connect to the PC3 pin (the 13th one) of the chip processor U1. In adjusting light, according to the brightness changing direction of the LEDs, a dynamic indication can be shown to tell the change of the brightness, from the bright to the dark or from the dark to the bright. For example, if the LEDs flashing in a direction as LED1→LED2→LED3 represent enhancing the brightness gradually, then they represent lessening the brightness while flashing in a reverse direction as LED3→LED2→LED1.

The advantages of the invention are described below.

Different current flowing to the sampling circuit composed of the manganese-copper line or the current transformer T1 generates different voltage, and the bigger the current, the greater the voltage. With the signal adjusting circuit 2 to control the conduction of the triacs Q1 and Q2, the thyristor TR1 and the relay can be successively controlled to stop a load working, so as to achieve a purpose of restricting power. When the triacs Q1 and Q2 are not connected with each other, the thyristor TR1 is still characteristically working to control the on/off of the relay until the switch SW SPST is turned off or the power line is unplugged. If the current-limiting and the light-adjusting functions are needed, the control output circuit 3 can be replaced with the light-adjusting input circuit 8, the chip processor control circuit 7, the zero-crossing detection circuit 6 and the silicon controlled rectifier control output circuit 5. The sampling circuit and the power circuit 1 are kept the same. The signal adjusting circuit 2 is slightly changed. And, by means of the programmable characteristic of the chip processor U1 to adjust the conducting phase and angle of the two-way silicon controlled rectifier BT4 in controlling the brightness of a load such as a tungsten lamp, the function of adjusting light can therefore be effected. Compared with conventional commercial products, the present invention with the current-limiting function does not contain the operational amplifier and the comparator as shown in FIGS. 1 and 2, not only saving cost, but also lessening bulk. As for the present invention with current-limiting and light-adjusting functions as shown in FIGS. 3 and 4, its integration is advanced because the two-way silicon controlled rectifier BT4 is controlled by the chip processor U1, saving some devices further. Therefore, the present invention really has a low cost, a small size and a high precision.

Additionally, with the programmable advantage of the chip processor U1, a load such as a lamp can be controlled to work with a lower power if it is detected working over a restricting power. For example, if the restricting power is 190 watts and a lamp of 300 watts is installed, the chip processor U1 is to detect the overload to control the conducting time of the two-way silicon controlled rectifier BT4 to output with a half power that is checked again if over or not. If it is still over the restricting value, the output power is to be halved until less than 190 watts. Within the controlled scope, light brightness can be still adjusted by the button or the varistor to meet diverse requirements.

While the preferred embodiment of the invention has been described above, it will be recognized and understood that various modifications may be made therein and the appended claims are intended to cover all such modifications that may fall within the spirit and scope of the invention.

What is claimed is:

1. A light-adjusting and current-limiting control circuit comprising:
a sampling circuit composed of a resistor R24 made of manganese copper;
a power circuit 1 provided with three resistors R1, R2 and R3, four capacitors C1, C3, C4 and C5, two diodes D1 and D2, a varistor, a zener diode Z2;
a signal adjusting circuit 2 provided with a diode D4, six resistors R4, R5, R6, R7, R8 and R9, a Varistor RT1, two triacs Q1 and Q2, and two capacitors C6 and C7;
a control output circuit 3 provided with a thyristor TR1, a diode D5, a relay and an LED;
a switch SW SPST, said resistors R1 and R2, said diode D2 and said resistor R3 subsequently connected in series from an input port CN3;
said resistor R3 connected to a negative pole of said diode D2, said capacitor C1 connected with said resistor R1 in parallel, said diode D1 connected between a positive pole of said diode D2 and the ground in parallel, a positive pole of said diode D1 connected to the ground, said capacitor C3 connected between said negative pole of said diode D2 and the ground in parallel, a negative pole of said capacitor C3 connected to the ground, said zener diode Z2 and said capacitors C4 and C5 connected between said resistor R3 and the ground in parallel, a positive pole of said zener diode Z2 connected to a negative pole of said capacitor C4;
an input port CN4 connected to the ground, an output port OUT1 connected between a switch SW SPST and said resistor R1, said output port OUT2 connected to the ground by passing through a control port of said relay and said resistor R24; and
said resistor R4, said diode D4 and said resistors R5 and R6 orderly connected between said resistor R1, said control port of the relay and a base of said triac Q1 in series, an emitter of said triac Q1 connected to the ground, said capacitor C7 connected between said base of said triac Q1 and the ground in parallel, a negative pole of said capacitor C7 connected to the ground, said varistor RT1 connected between said resistors R5 and R6, said varistor RT1 also connected to the ground in parallel, a negative pole of said diode D4 connected with said capacitor C6 that has its negative pole connected to the ground in parallel, a collector of said triac Q1 passing through said resistor R7 to connect to a negative pole of said zener diode Z2, a base of said triac Q2 connected to a collector of said triac Q1, an emitter of said triac Q2 connected to said negative pole of said zener diode Z2, a collector of said triac Q2 passing through said resistor R8 to connect to a gate of said thyristor TR1, said resistor R9 connected between said gate of said thyristor TR1 and the ground, said LED connected between a cathode of said thyristor TR1 and the ground, an anode of said thyristor TR1 passing through said Relay to connect to a positive pole of said capacitor C3, said diode D5 connected between two ends of said relay in parallel, a positive pole of said diode D5 connected to said anode of said thyristor TR1.

2. The light-adjusting and current-limiting control circuit as claimed in claim 1, wherein a zener diode Z1 is connected between said negative pole of said diode D2 and the ground with its anode connected to the ground.

3. The light-adjusting and current-limiting control circuit as claimed in claim 2, wherein a capacitor C2 is connected between two ends of said zener diode Z1 in parallel.

4. The light-adjusting and current-limiting control circuit as claimed in claim 3, wherein said zener diode Z1 is of 24 volts, with 24 volts for a negative pole of said zener diode Z1, 5.6 volts for said zener diode Z2, with 5 volts for said negative pole of said zener diode Z2.

5. The light-adjusting and current-limiting control circuit as claimed in claim 1, wherein said sampling circuit is a current transformer T1 that has its input connected at two ends of said resistor R4, one output of said current transformer T1 passing through said control port of said relay to connect to said output port OUT2, the other output of said current transformer T1 connected to said input port CN4.

6. The light-adjusting and current-limiting control circuit as claimed in claim 1, wherein a diode D3 has its negative pole connected to between a positive pole of said diode D4 and said resistor R4 and its positive pole connected to the ground.

7. The light-adjusting and current-limiting control circuit as claimed in claims 1˜6, wherein a silicon controlled rectifier control output circuit 5, a zero-crossing detection circuit 6, a chip processor control circuit 7 and a light-adjusting input circuit 8 are additionally provided, said silicon controlled rectifier control output circuit 5 including a two-way silicon controlled rectifier BT4, three resistors R22, R23 and R14, and two capacitors C9 and C12, said zero-crossing detection circuit 6 including four resistors R15, R16, R17 and R18, and a triac Q3, said chip processor control circuit 7 including a chip processor U1, two resistors R34 and R77, two capacitors C66 and C8, and a switch (option), said light-adjusting input circuit 8 using a light-adjusting button and/or a light-adjusting varistor, said light-adjusting button being single or double, said double one including an UP button and a DOWN button, said light-adjusting varistor including a varistor VR2 and a capacitor C77, said control output circuit 3 including a triac Q4, a diode D5, a relay and a resistor R44;
said two-way silicon controlled rectifier BT4 having its one electrode connected to said output port OUT2 and its another electrode connected to said resistor R24 or one output port of said current transformer T1 and its gate connected to the ground after passing through said resistor R23, said capacitor C9 and said resistor R14 subsequently connected between a gate of said two-way silicon controlled rectifier BT4 and a pin PA3 of said chip processor U1 in series, said capacitor C12 and said resistor R22 connected at two electrodes of said two-way silicon controlled rectifier BT4 in parallel after having connected each other in series;
a base of said triac Q3 passing through said resistor R15 to connect to said output port OUT1, said resistor R16 connected between said base of said triac Q3 and the ground in parallel, said triac Q3 having its emitter connected to the ground and its collector passed through said resistor R17 to connect to said negative pole of said zener diode Z2 and passed through said resistor R18 to connect to a zero pin of said chip processor U1;
said chip processor U1 having its VDD pin connected to said negative pole of said zener diode Z2 and passed through said capacitor C8 to connect to the ground, a PD0 pin of said chip processor U1 passing through said resistor R77 and said switch (option) to connect to the ground, a reset pin of said chip processor U1 passing through said capacitor C66 to connect to the ground and passing through said resistor R34 to connect to said negative pole of said zener diode Z2;
said varistor VR2 having its two ends respectively connected to the PC2 pin and the PC0 pin of said chip processor U1, an intermediate pin of said varistor VR2 connected to said PC1 pin of said chip processor U1, said PC0 pin of said chip processor U1 passing through said capacitor C77 to connect to the ground;
said button UP connected between a PB0 pin of said chip processor U1 and the ground, said button DOWN connected between a PB1 pin of said chip processor U1 and the ground; and
said triac Q2 having its collector connected to a PA1 pin of said chip processor U1 and its base connected to said collector of said triac Q1 through a resistor R12.

8. The light-adjusting and current-limiting control circuit as claimed in claim 7, wherein a model of said chip processor U1 is SH69P20C.

9. The light-adjusting and current-limiting control circuit as claimed in claim 8, wherein a sound and light warning circuit 4 is added, said sound and light warning circuit 4 provided with a buzzer warning circuit and/or a LED warning circuit; said buzzer warning circuit including a buzzer and a resistor R51, said buzzer having one pin passed through said resistor R51 to connect to a PD2 pin of said chip processor U1, another pin of said buzzer connected to said negative pole of said zener diode Z2; said LED warning circuit including a LED4 and a resistor R61, said LED4 having its negative pole connected to the ground and its positive pole passed through said resistor R61 to connect to a PD1 pin of said chip processor U1.

10. The light-adjusting and current-limiting control circuit as claimed in claim 1, wherein an LED indicating circuit 9 is added, said LED indicating circuit 9 provided with three light emitting diodes LED1, LED2 and LED3, and three resistors R19, R20 and R21, said LED1 having its negative pole connected to the ground and its positive pole passed through said resistor R19 to connect to a PB2 pin of said chip processor U1, said LED2 having its negative pole connected to the ground and its positive pole passed through said resistor R20 to connect to a PB3 pin of said chip processor U1, said LED3 having its negative pole connected to the ground and its positive pole passed through said resistor R21 to connect to a PC3 pin of said chip processor U1.
